(19) United States
(12) Patent Application Publication
(10) Pub. No.: US 2013/0166904 A1
(43) Pub. Date: Jun. 27, 2013

(54) MULTIMEDIA PRIVACY ENHANCER

(71) Applicants: Antonio Manuel Amaya Calvo, Madrid (ES); Miguel Ochoa Fuentes, Madrid (ES)

(72) Inventors: Antonio Manuel Amaya Calvo, Madrid (ES); Miguel Ochoa Fuentes, Madrid (ES)

(21) Appl. No.: 13/817,715

(22) PCT Filed: Jul. 8, 2011
(86) PCT No.: PCT/EP2011/061620

§ 371 Date: Mar. 14, 2013

(30) Foreign Application Priority Data
Aug. 18, 2010 (ES) P201031264

(51) Int. Cl. H04L 29/06

(52) U.S. Cl. CPC H04L 63/0428; H04L 63/08
USPC 713/151; 713/150; 713/168

(57) ABSTRACT

The disclosure relates to a method and a system for protecting private multimedia content which comprises a central server in communication with a client application, characterized in that a user uploads a private multimedia content to the central server and a reference file is generated including a pointer to the private multimedia content and access requirements associated. The reference file is uploaded to multimedia servers and other users of the network download it through a web browser. The client application extracts the pointer from the reference file and sends a request to the central server, where it is checked if the request fulfils the access requirements associated for the private multimedia content requested.

### TECHNICAL FIELD OF THE INVENTION

The present invention relates to the technical field of privacy of data and more specifically to the protection of private multimedia content on telecommunication networks.

### BACKGROUND OF THE INVENTION

Internet services boom imply an increase of private and confidential information deposited by individuals and companies on the service providers. Web 2.0 services are based upon users providing the content of the services, and much of that content is multimedia (image, sound and/or video) that is private and users would like to have control over who can see their content.

Thus, social networks and other content sharing sites are at their very peak and it is a matter of fact that they provide several methods for restricting access to personal information, giving users the ability to restrict access to their content. Each social network/content sharing provider has its own privacy policy or access requirements that it enforces through its service. But enforcement does not extend past the boundary of the service provider, and even inside that boundary most of the times the enforcement is not backed by technical means.

As an example, Facebook has been subject to some criticism lately because of the way applications could access data of the users even if they had restricted access, or images could be accessed directly by their URL whatever the user's privacy settings for that image were, or even after the image had been deleted. So, this is where the current debate about privacy comes in to place.

Privacy enforcement solutions, as they are implemented on current systems, when they are implemented, restrict access to the content on each of the Social Networks/content sharing sites. They might restrict access to any individual file or data set by forcing users to authenticate themselves and checking if their identities are on the authorized users' list.

On current systems, privacy policies are implemented and enforced by each service provider. That means that any user that has his information distributed on several providers, has to keep tabs of different privacy policies that are usually written on vague terms.

Furthermore, end users can just ignore privacy policies. Since the current systems allow storage of downloaded media and direct exchange of information between users, they can just exchange some private content violating the privacy policy

There is some related previous work on the privacy area:

US 2007/021379 A1, published on Nov. 22, 2007, describes a ‘Method, components and system for tracking and controlling end user privacy’ and deals with methods for controlling and tracking who accesses end user's private information on a converged network. The private data this system protects are the context private data (data derived from any user's use of the network services). The system described on the patent should be implemented on network nodes and would apply privacy metrics to all data passing to every node.

PCT/US2006/040106, ‘Privacy proxy of a digital security system for distributing media content to a local area network’ describes a Digital Rights Management System on which content is encrypted and distributed on a Local Area Network. Only systems that have an adequate license file will be authorized to decrypt and view the content.

‘Pos Multimedia Privacy Keeper’, is a Windows application to protect local multimedia files against unauthorized access by means of a password.

‘Privacy Enforcement with an Extended Role-Based Access Control Model’ describes an extended role-based access control (RBAC) model, called Privacy-Aware Role-Based Access Control (PARBAC) model, for enforcing privacy policies within an organization.

Most of current Web 2.0 sites have (as required by law on most countries) some kind of privacy policy, allowing in theory for users to restrict who can access their private data, including multimedia data. On practice, though, the current implementations have the following unsavory characteristics:
They are ad-hoc solutions. Each Web 2.0 service implements its own privacy policy, with its own enforcement and rules.
Often they are incomplete solutions. They restrict access to content when its accessed the way the site developer envisioned it, but they allow direct access to content when the normal site navigation is bypassed (by accessing a URL directly instead of navigating to it, for example).
They do not control copy and redistribution of private data. There's no technical measure in place preventing any user to copy and redistribute another user's private data.
If some content has been uploaded to several sites, there's no easy way to delete the content from all the sites, other than going to each of the sites and deleting it.

### SUMMARY OF THE INVENTION

The invention described on this paper aims to solve all the aforementioned problems, by providing a unique, centralized point in which access requirements to a private multimedia content can be specified, tailored to the users' need, and where the user has total control over who can access his private content. Copy and redistribution of private data are prevented by the system too.

Access requirements for the content include a set of logical conditions over the following parameters: applicant identity, referrer, time, geographical location of the applicant, IP address (or subnet) of the applicant. Applicant, in this context, is the user making the request for any protected content. Applicant identity is the identity of the user applying for a private multimedia content. Applicant's authentication can be delegated to an external service (and thus the condition could include a Facebook identity, for example) or the content owner can request the authentication to be realized by the central server. Thus, application identity can be either an external or an internal identity. Referrer, in this context, means the web page or service from where the applicant is applying for the protected content. Referrer can be expressed just as a service (such as ‘Facebook’) or as a concrete URL (Uniform Resource Locator). Time, in this context, means a time interval, expressed only as a daily time interval (for example, allow download from 8AM till 5PM only) or as a concrete interval (allow download from Aug. 1, 2008 till Aug. 20, 2010 only). Geographical location, in this context, means a concrete country, city, or region (like Europe). IP address (or subnet) in this context means either a concrete IP address or a subnet expression.

One aspect of the invention refers to a method for protecting private multimedia content, provided by an owner user for sharing among the users of a network. This method comprises uploading a private multimedia content to a central server and specifying, through a web browser, access requirements associated to said private multimedia content and comprising logical conditions over a set of parameters to determine if a user is authorized to visualize the private multimedia content. So the owner user decides what he wants to share and who can access to that content.

The method also cares about generating a reference file in the central server comprising a pointer to the private multimedia content stored in the central server. This is a way to make some content available unless it is just stored in the central server.

Next step is uploading the reference file to multimedia servers of the network which have accessed by the users of the network. Once there, the reference file is obtained through a web browser and the method extract the pointer to the private multimedia content from the reference file through a client application.

Finally, an access request to the private multimedia content comprising the pointer to the private multimedia content is sent from the client application to the central server, where the access request is checked out to meet the access requirement associated to the private multimedia content specified by the owner user.

According to the result of the checking, the central server can generate an access authorization or an access denial to the private multimedia content, depending on whether the access request satisfies the access requirements or not. Thus, the method send the private multimedia content to the user of the network, in the case that the checking is satisfactory, or, on the contrary case, it is sent an access denial message through the client application.

Optionally, the pointer to the private multimedia can be included into the reference file as metadata or as a digital watermark. The system uses metadata when the data format allows for the introduction of metadata, and the external services where the pointer is stored does not overwrite the metadata. Otherwise, it is used digital watermarking techniques.

The access request to private multimedia content, which is sent to the central server by a user of the network, who is an applicant, may comprise information about, at least, one parameter selecting from: applicant identity, referrer, time, geographical location of the applicant and IP address of the applicant to make safer the method by checking out that, said at least one parameter, meets the access requirements associated to the private multimedia content on the central server to determine if the user of the network is authorized. All the parameters have been defined before.

Encryption techniques are also considered to protect the content from unauthorized users. Thus it is proposed a session key, generated on an encryption module, to encrypt the private multimedia content requested by a user of the network or an access denial message before sending it, a session key generated on the encryption module of the central server, using the pointer to a private multimedia content as key seed. Using these encryption techniques implies, obviously, the step of decrypting the private multimedia content. Decrypting is made on the client application using a session key and, at last, the private multimedia content is showed running on a protected memory module of the client application, protected through Trusted Platform Module technology.

The storage encryption keys are not shared out of the server, so all data transit out of the client application is encrypted and since the application does not allow the copy or local storage of private multimedia content, this cannot be accessed by unauthorized users.

The encryption can be implemented in many ways, like through a symmetric algorithm, for example.

Sending private multimedia content from the central server to the client application can be made using HTTP/HTTPS transport to protect the transmission.

Other aspect of the invention refers to a system for protecting private multimedia content, provided by an owner user for sharing it among the users of a network. This system comprises a client application in communication with a central server.

The client application is configured to extract a pointer to a private multimedia content, generated by a central server and obtained through a web browser, from a reference file. It is also configured to communicate a user of the network with the central server sending an access request comprising the pointer to a private multimedia content to the central server.

The central server is configured to store a private multimedia content associated to access requirements; to generate a reference file which comprises a pointer to the private multimedia content; and to check that an access request to a private multimedia content, sent through the client application, meets the access requirements associated to said private multimedia content.

Besides, the client application can be configured to receive multimedia content from the central server and the central server is further configured to generate an access authorization to a private multimedia content when an access request to said private multimedia content meets the access requirements, then the central server sends said private multimedia content to a user of the network through the client application. It is also proposed to configure the central server to generate an access denial to a private multimedia content when an access request to said private multimedia content does not meet the access requirements, then the central server sends an access denial message to a user of the network through the client application.

The system may include an encryption module in the central server configured to encrypt the private multimedia content, provided by the owner user, through a session key generated using the pointer to the private multimedia content as key seed, before storing the private multimedia content on the central server. This encryption module may also been configured to encrypt the private multimedia content, provided by the owner user, through a session key generated using the pointer to the private multimedia content as key seed, before sending the private multimedia content on the central server. Obviously, including this encryption module entails another module to decrypt and show the private multimedia content, so it is proposed a protected memory module in the client application, protected by mean of Trusted Platform Module technology, configured to decrypt the private multimedia content, received from the central server.

The invention disclosed provides owner users with total control over their private multimedia contents:
Effectively restrict who can access their private multimedia content, where they can access it and when they can access it.
Discontinue the network presence of any private multimedia content they no longer deem appropriate to be public, even to a restricted set of the users.
Have a centralized place on which they can manage their own access requirements for all their content.
Be independent of web 2.0 providers' interpretation of privacy.

The above features and advantages do not limit the present invention, and those skilled in the art will recognize additional features and advantages upon reading the following detailed description, and upon viewing the accompanying drawings.

### DESCRIPTION OF THE DRAWINGS

To complement the description which is being made and for the purpose of aiding to better understand the features of the invention according to a preferred practical embodiment thereof, a drawing is attached as an integral part of this description, in which the following has been depicted with an illustrative and non-limiting character:

FIG. 1 shows a block diagram illustrating the steps of the invention

### DETAILED DESCRIPTION OF THE INVENTION

Here below a practical implementation in accordance to an embodiment of the invention are described.

The system comprises two main components:
A client application 20 that allow users of the network to access the private multimedia content represented by a reference file, that is called Privacy Enhanced File (PEF). The application runs as a content plug-in on browsers to allow a seamless user experience. The client application accesses the server using https protocol to download an encrypted version of the private multimedia content.
A central server 21, implemented as a web service, which:
   Allow end users to upload raw multimedia data, with an access requirements associated, using a standard web browser.
   Send the user of the network a Privacy Enhanced File (PEF) that represents their private multimedia content. A Privacy Enhanced File is a file of the same type (video, audio, image) of the represented private multimedia content that only has a pointer to the actual data. That is, a PEF file does not, in fact, contain the original, private multimedia content in any way or form. The private multimedia content is stored only on the central server. Each private multimedia content file uploaded by any user generates a different PEF that the rest of the users of the network are able to download to his private equipment. The PEF is generated by the central server anytime the user uploads new private multimedia content.
   Allow end users to access and modify the access requirements for their stored private multimedia content. Users are able to establish default access requirements and specific access requirements for each private multimedia content uploaded.
   Allow users to delete their own private multimedia content. Once some private multimedia content is deleted, the PEF file associated to it is made automatically invalid. PEF files do not include any real private multimedia content, only a pointer to where the private multimedia content is stored. Real private multimedia content is transmitted encrypted and shown but never stored locally.
   Check access requests for private multimedia content against the access requirements for the desired private multimedia content and either reject the request or send an encrypted version of the private multimedia content.

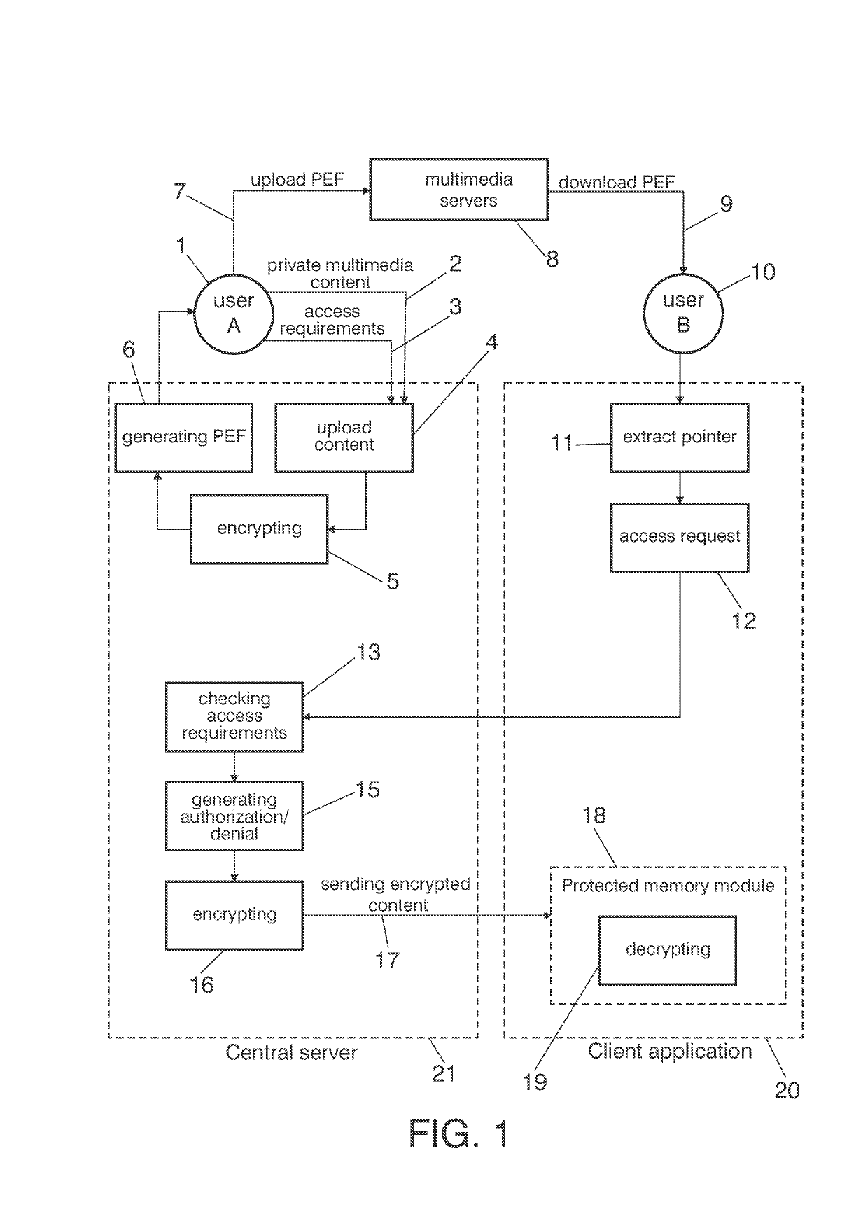

FIG. 1 illustrates the process in a schematic block diagram. The steps of the whole process are as follows:
First the owner of a private data multimedia, user A 1, uploads 4 the content 2, using a standard web browser and a web interface to the central server, along with the desired access requirements 3.
Then, an encryption module in the central server, receives the private multimedia content and a reference to the access requirements. The encryption module encrypts 5 the private multimedia content associated to the reference.
After encrypting, the central server generates a Privacy Enhanced File 6, including a pointer to the private multimedia content and serves it to the user A.
User A upload 7 the PEF to multimedia servers 8, where other users of the network have access.
User B 10 accesses to a multimedia server and download 9 the PEF through a standard web browser. Since the client application is installed on the computer, the browser passes the PEF to the client application.
The client application extracts 11 the pointer from the Privacy Enhanced File and collects some context information. Context information includes the requesting user's identity, his IP address, the page from where the PEF including the pointer was obtained and any other information to evaluate the access requirements of the private multimedia content referenced.
An access request 12, including the pointer to the private multimedia content extracted from the PEF and the context information, is sent from the client application to the central server.
The central server receives the access request to the private multimedia content and checks 13 the access requirements for the private multimedia content requested. It is checked if the context fulfils the access requirements.
The central server generates an access authorization 14 if the context fulfils the context or an access denial 15 if the context does not fulfil the context.
If an access authorization has been generated, the encryption module reencrypts 16 the encrypted private multimedia content with a symmetrical session key. The private multimedia content is reencrypted because the encryption keys are not shared outside of the central server. The session key is derived from the context collected before. If an access denial has been generated, the encryption module encrypt 16 an “access denied” message with a symmetrical session key.
The central server sends 17 the encrypted content to the client application using HTTP/HTTPS transport. Note that the encrypted content sent can be the requested private multimedia content or an “access denied” message.
The encrypted content is received by a protected memory module 18 on the client application. The memory is protected using Trusted Platform Module technology. This encrypted content is then decrypted 19 and shown on a client output device.

The invention is obviously not limited to the specific embodiments described herein, but also encompasses any variations that may be considered by any person skilled in the art (for example, as regards the choice of components, configuration, etc.), within the general scope of the invention as defined in the appended claims.

1-17. (canceled)

18. A method for protecting private multimedia content, provided by an owner user for sharing among the users of a network, comprising:
a) uploading a private multimedia content to a central server and specifying, through a web browser, access requirements associated to said private multimedia content and comprising logical conditions over a set of parameters to determine if a user is authorized to visualize the private multimedia content;
b) generating a reference file in the central server, the reference file comprising a pointer to the private multimedia content stored in the central server;
c) uploading the reference file to multimedia servers of the network which the users of the network have access to;
d) obtaining the reference file from at least one of the multimedia servers through the web browser;
e) extracting the pointer to the private multimedia content from the reference file through a client application;
f) sending, from the client application to the central server, an access request to the private multimedia content comprising the pointer to the private multimedia content and comprises information about, at least, one parameter selected from:
applicant identity indicating the identity of the user applying for the private multimedia content and the authentication of the identity is made by an external service unless the owner user request the authentication to be made for the central server;
referrer indicating the web page or service from where the applicant is applying for the private multimedia content;
time interval indicating a daily time interval or a concrete interval;
geographical location of the applicant;
IP address of the applicant.
g) checking by the central server whether the access request to the private multimedia content meets the access requirements associated to the private multimedia content specified by the owner user.
h) after checking on step g), that the access request to a private multimedia content for a user of the network meets the access requirements associated to the private multimedia content, an access authorization to the private multimedia content is generated by the central server and the private multimedia content is sent to the user of the network through the client application;
i) in the case of after checking on step g) that the access request to a private multimedia content for a user of the network does not meet the access requirements associated to the private multimedia content, an access denial to the private multimedia content is generated by the central server and a denial access message is sent to the user of the network through the client application; and
j) generating a session key in an encryption module, using the pointer to a private multimedia content as key seed, and the private multimedia content requested by a user of the network is encrypted before sending said private multimedia content to said user of the network.

19. The method according to claim 18, wherein the pointer to the private multimedia content is included into the reference file as metadata.

20. The method according to claim 18, wherein the pointer to the private multimedia content is included into the reference file as a digital watermark.

21. The method according to claim 18, wherein the at least one parameter is checked to meet the access requirements associated to the private multimedia content on the central server to determine if the user of the network is authorized.

22. The method according to claim 18, further comprising decrypting the private multimedia content, sent from the central server, using a session key, running on a protected memory module protected through Trusted Platform Module technology.

23. The method according to claim 18, wherein encrypting is performed by a symmetric algorithm.

24. The method according to claim 18, wherein sending private multimedia content from the central server to the client application is performed by using HTTP/HTTPS transport protocol.

25. A system for protecting private multimedia content, provided by an owner user for sharing it among the users of a network, comprising:
a client application configured to:
extract a pointer to a private multimedia content, generated by a central server and obtained from a reference file uploaded to multimedia servers through a web browser;
communicate a user of the network with the central server sending to the central server an access request from the user, the access request comprising the pointer to the private multimedia content;
receive private multimedia contents from the central server;
a central server configured to:
store private multimedia contents associated to access requirements;
generate a reference file which comprises a pointer to a private multimedia content;
check whether an access request to the private multimedia content, sent through the client application, meets the access requirements associated to said private multimedia content;
generate an access authorization to the private multimedia content when an access request to said private multimedia content meets the access requirements, and configured for sending said private multimedia content to a user of the network through the client application;
generate an access denial to a private multimedia content when an access request to said private multimedia content does not meet the access requirements, and configured to send an access denial message to a user of the network through the client application; and
an encryption module in the central server configured to encrypt the private multimedia content, provided by the owner user, through a session key generated using the pointer to the private multimedia content as key seed, before sending the private multimedia content to the client application.

26. The system according to claim 25, further comprising a protected memory module, protected by means of Trusted Platform Module technology, configured for decrypting the private multimedia content, received from the central server.
